(19) United States
(12) Patent Application Publication
(10) Pub. No.: US 2009/0268834 A1
(43) Pub. Date: Oct. 29, 2009

(54) METHOD AND SYSTEM FOR PREDICTING CHANNEL QUALITY INDEX (CQI) VALUES FOR MAXIMUM LIKELIHOOD (ML) DETECTION IN A KXK MULTIPLE INPUT MULTIPLE OUTPUT (MIMO) WIRELESS SYSTEM

(76) Inventors: Sirikiat Ariyavisitakul, Alpharetta, GA (US); Eric Ojard, San Francisco, CA (US); Jun Zheng, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/430,294

(22) Filed: Apr. 27, 2009

Related U.S. Application Data
(60) Provisional application No. 61/048,118, filed on Apr. 25, 2008.

(51) Int. Cl. H04L 5/12; H04L 27/06

(52) U.S. Cl. 375/262; 375/341

(57) ABSTRACT

Aspects of a method and system for predicting CQI values for ML detection in a K×K MIMO system are presented. In one aspect of the system, a CQI value for a K×K MIMO communication system may be computed by decomposing the K×K MIMO system into a series of 2×2 MIMO systems. For each 2×2 MIMO system a CQI value may be computed by reverse mapping a PER computed for the 2×2 MIMO system and an SNR value for a SISO communication system. By summing CQI values among the series of 2×2 MIMO systems a CQI value for the K×K MIMO system may be computed. Based on the computed CQI value for the K×K MIMO system, a coding rate may be selected. The selected coding rate may be selected to maximize a computed information throughput rate at a MIMO receiver that utilizes ML detection.

### CROSS-REFERENCE TO RELATED APPLICATIONS/INCORPORATION BY REFERENCE

This application makes reference, claims priority to, and claims the benefit of U.S. Application Ser. No. 61/048,011 filed Apr. 25, 2008.

This application makes reference to:

U.S. application Ser. No. ______ (Attorney Docket No. 19474US02) filed Apr. 27, 2009; and
U.S. application Ser. No. 12/207,721 filed Sep. 10, 2008.

Each of the above stated applications is hereby incorporated herein by reference in its entirety.

### FIELD OF THE INVENTION

Certain embodiments of the invention relate to wireless communication. More specifically, certain embodiments of the invention relate to a method and system for predicting channel quality index (CQI) values for maximum likelihood (ML) detection in a K×K multiple input multiple output (MIMO) wireless system.

### BACKGROUND OF THE INVENTION

Multiple input multiple output (MIMO) systems are wireless communications systems that may transmit signals utilizing a plurality of transmitting antennas, and/or receive signals utilizing a plurality of receiving antennas. Communications between MIMO systems may be based on specifications from the Institute of Electrical and Electronics Engineers (IEEE). A MIMO system that receives a signal Y may compute a channel estimate matrix, H, based on the received signal. The signal may comprise information generated from a plurality of information sources. Each such information source may be referred to as a spatial stream.

A MIMO transmitter may combine spatial streams to generate one or more RF chains. Alternatively, each RF chain may correspond to a distinct spatial stream. A group of RF chains may be concurrently transmitted from the transmitting MIMO system via a plurality of transmitting antennas. The signals concurrently transmitted by the plurality of transmitting antennas, referred to as spatial stream signals, may be represented as a transmitted signal vector X. The spatial stream signals xᵢ (where i is a spatial stream index variable), which comprise the signal vector X, may propagate across a communication medium en route from the transmitting MIMO system to receiving MIMO system. The signal transfer characteristics of the communication medium may be represented by a channel matrix, H. A receiving MIMO system may utilize a plurality of receiving antennas when receiving the signals. The signals concurrently received by the plurality of receiving antennas may be represented as a received signal vector, R.

The MIMO communication system may be represented mathematically as follows:

R=HX+N [1]

where R represents a column vector of signals received by each of a plurality of Nrx receiving antennas: r₁, r₂, . . . , and r_{Nrx}; X represents a column vector of signals transmitted by each of a plurality of Ntx transmitting antennas: x₁, x₂, . . . , and x_{Ntx}; H represents a matrix of channel estimates comprising Nrx rows and Ntx columns; and N represents a column vector of noise received by each of the Nrx receiving antennas: n₁, n₂, . . . , and n_{Nrx}, Statistically, the noise elements, nᵢ, are typically considered to be independent and identically distributed complex Gaussian random variables.

In equation [1] each of the spatial stream signal values xᵢ may be represented by one or more bits b₁, b₂, . . . , and b_{MOD(i)}. Each spatial stream signal value, which comprises the bits b₁, b₂, . . . , and b_{MOD(i)}, may be referred to as a “symbol”. The number of bits MOD(i) in each symbol may be determined based on the modulation type utilized for generating the corresponding spatial stream signal xᵢ at the MIMO transmitter. Each value for the transmitted signal vector, X, may be represented as comprising the collective bits from the set of concurrently transmitted symbols. The total number of bits represented in vector X is a summation of values MOD(i) for the spatial streams identified by i=1, 2, . . . , and NSS.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for predicting channel quality index (CQI) values for maximum likelihood (ML) detection in a K×K multiple input multiple output (MIMO) wireless system, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is an exemplary diagram illustrating an exemplary MIMO transceiver system, in accordance with an embodiment of the invention.

FIG. 2 is an exemplary diagram illustrating an exemplary K×K MIMO communication system with ML detection, in accordance with an embodiment of the invention.

FIG. 3 is a graph that presents PER values as a function of SNR for an exemplary SISO communication system, in accordance with an embodiment of the invention.

FIG. 4 is a flowchart illustrating exemplary steps for generating a reverse mapping function utilizing radial basis function networks, in accordance with an embodiment of the invention.

FIG. 5 is a flowchart illustrating exemplary steps for CQI prediction utilizing radial basis function networks, in accordance with an embodiment of the invention.

### DETAILED DESCRIPTION OF THE INVENTION

Certain embodiments of the invention relate to a method and system for predicting channel quality index (CQI) values for maximum likelihood (ML) detection in a K×K multiple input multiple output (MIMO) wireless system. In one aspect of the system, a CQI value for a K×K MIMO communication system may be computed by decomposing the K×K MIMO system into a series of 2×2 MIMO systems. For each 2×2 MIMO system a CQI value may be computed by reverse mapping a PER computed for the 2×2 MIMO system and an SNR value for a SISO communication system. The reverse mapping function may be computed by utilizing radial basis function networks. By summing CQI values among the series of 2×2 MIMO systems a CQI value for the K×K MIMO system may be computed. Based on the computed CQI value for the K×K MIMO system, a coding rate may be selected. The coding rate may be selected to maximize a computed information throughput rate at a MIMO receiver that utilizes ML detection.

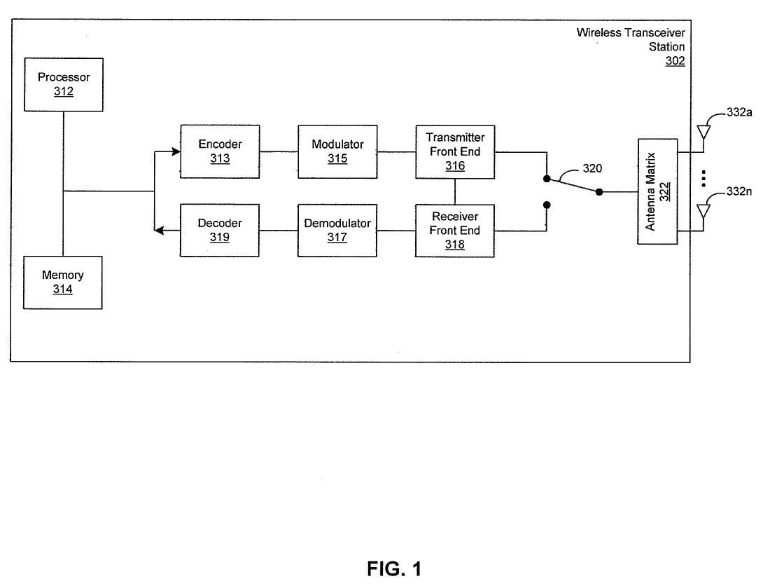

FIG. 1 is an exemplary diagram illustrating an exemplary MIMO transceiver system, in accordance with an embodiment of the invention. Referring to FIG. 1, there is shown a wireless transceiver station 302 and a plurality of antennas 332a . . . 332n. The wireless transceiver station 302 is an exemplary wireless communication device, which may be utilized as a transmitter and/or receiver. The plurality of antennas 332a . . . 332n may enable the wireless transceiver station 302 to transmit and/or receive signals, for example radio frequency (RF) signals, via a wireless communication medium. The wireless transceiver station 302 shown in FIG. 1 may also be depicted as comprising one or more transmitting antennas, which are coupled to the transmitter front end (FE) 316 and one or more receiving antennas, which may be coupled to the receiver front end (FE) 318 without loss of generality.

The exemplary wireless transceiver station comprises a processor 312, a memory 314, an encoder 313, a decoder 319, a modulator 315 a transmitter FE 316, a demodulator 317, a receiver FE 318, a transmit and receive (T/R) switch 320 and an antenna matrix 322. The antenna matrix 322 may enable selection of one or more of the antennas 332a . . . 332n for transmitting and/or receiving signals at the wireless transceiver station 302. The T/R switch 320 may enable the antenna matrix 322 to be communicatively coupled to the transmitter FE 316 or receiver FE 318.

The transmitter FE 316 may enable the generation of signals, which may be transmitted via the selected antennas 332a . . . 332n. The encoder 313 may receive data from the processor 312 and/or memory 314 and generate encoded binary data. The encoded binary data may be generated by utilizing error correction coding, for example binary convolutional coding (BCC), and/or bit interleaving. The modulator 315 may receive encoded binary data from the encoder 313 and convert the encoded binary data to a data symbol representation based on one or more selected modulation types. The modulator 315 may generate one or more spatial streams to transmit the data symbols to the transmitter FE 316.

The receiver FE 318 may enable the processing of signals received via the selected antennas 332a . . . 332n. The demodulator 317 may receive data symbols from the receiver FE 318 and enable the generation of a plurality of soft decision values based on one or more selected modulation types. The soft decision values may be sent to the decoder 319. The decoder 319 may utilize the soft decision values to generate decoded binary data. The decoded binary data may be sent to the processor 312 and/or memory 314.

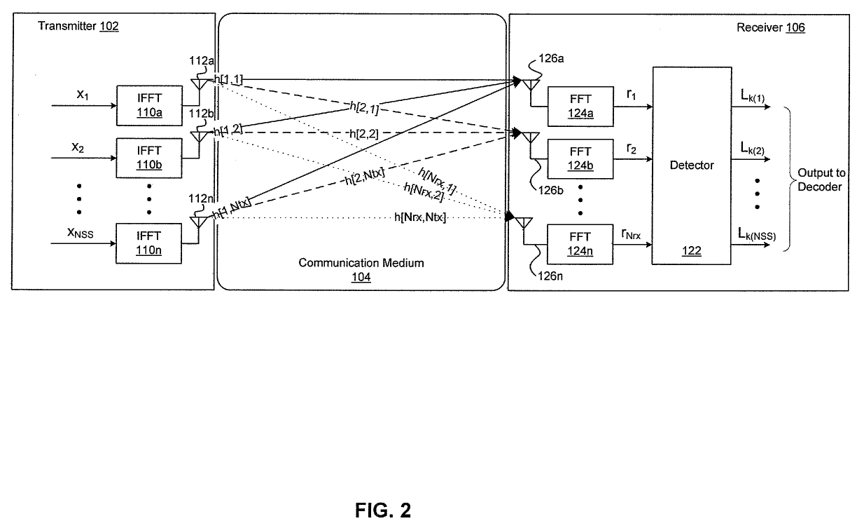

FIG. 2 is an exemplary diagram illustrating an exemplary K×K MIMO communication system, in accordance with an embodiment of the invention. Referring to FIG. 2, there is shown a MIMO transmitter 102, a MIMO receiver 106, and a communications medium 104. The communications medium 104 may represent a wireless communications medium, for example. The MIMO transmitter 102 may comprise a plurality of inverse fast Fourier transform (IFFT) blocks 110a, 110b, . . . , and 110n, and a plurality of antennas 112a, 112b, . . . , and 112n. The MIMO receiver 106 may comprise a plurality of antennas 126a, 126b, . . . , and 126n, a plurality of fast Fourier transform (FFT) blocks 124a, 124b, . . . , and 124n and a detector block 122.

In an exemplary embodiment of the invention, each of the plurality of IFFT blocks 110a, 110b, . . . , and 110n may receive a corresponding one of a plurality of NSS spatial stream signals x₁, x₂, . . . , and x_{NSS}. Each of the spatial stream signals may be generated, for example, by a modulator block 315 such as the one shown in FIG. 1A, and/or other circuitry which is commonly present in transmitter and/or transceiver systems. Such circuitry may include, for example, parsing circuitry, which distributes bits from a single input bit stream among the plurality of spatial streams, and constellation mapper circuitry, which utilizes a constellation associated with a modulation type to convert groups of bits within a given spatial stream into one of a plurality of signal levels. Each of the IFFT blocks 110a, 110b, . . . , and 110n may convert each of the corresponding spatial stream signals from a frequency domain representation to a time domain representation. Each of the time domain versions of the signals x₁, x₂, . . . , and x_{NSS} may be concurrently transmitted by a corresponding one of antennas 110a, 110b, . . . , and 110n. The plurality of concurrently transmitted signals may be represented as a column vector X.

Various embodiments of the invention may also be practiced when the transmitter 102 transmits signals by utilizing beamforming and/or space-time diversity coding. In such instance, the transmitter 102 may comprise a spatial mapping matrix. The spatial mapping matrix may receive a plurality of NSS spatial streams and output a plurality of Ntx transmit chain signals. Each of the transmit chain signals may be generated by computing a weighted sum from the plurality of spatial stream signals, where the weights may be determined by the spatial mapping matrix. Each of the IFFT blocks 110a, 110b, . . . , and 110n may convert each of the corresponding transmit chain signals from a frequency domain representation to a time domain representation. Each of the time domain version of the signals may be transmitted by a corresponding one of antennas 110a, 110b, . . . , and 110n. In such case, an effective channel estimate matrix for transmitted signals may be determined based on the product of the channel estimate matrix, which characterizes the communication medium, and the spatial mapping matrix.

Once again referring to FIG. 2, the antennas 126a, 126b, . . . , and 126n may receive signals, r₁, r₂, . . . , and r_{Nrx}, respectively, which propagate via the communication medium 104. The transmitted signal vector X may be altered as it propagates through the communication medium 104. The altered signals may be received at the MIMO receiver as a received signal vector R. The alteration of the transmitted signals may be represented by channel estimates h[i,j]. As shown in FIG. 2, the spatial stream signal x₁ which is transmitted by antenna 112a and received at antenna 126a may be altered based on a channel estimate h[1,1]. The spatial stream signal, x₂, which is transmitted by antenna 112b and received at antenna 126a may be altered based on a channel estimate h[1,2]. The spatial stream signal, x_{NSS}, which is transmitted by antenna 112n and received at antenna 126a may be altered based on a channel estimate h[1,Ntx].

The spatial stream signal, x₁, which is transmitted by antenna 112a and received at antenna 126b may be altered based on a channel estimate h[2,1]. The spatial stream signal, x₂, which is transmitted by antenna 112b and received at antenna 126b may be altered based on a channel estimate h[2,2]. The spatial stream signal, x_{NSS}, which is transmitted by antenna 112n and received at antenna 126b may be altered based on a channel estimate h[2,Ntx].

The spatial stream signal x₁ which is transmitted by antenna 112a and received at antenna 126n may be altered based on a channel estimate h[Nrx,1]. The spatial stream signal x₂ which is transmitted by antenna 112b and received at antenna 126n may be altered based on a channel estimate h[Nrx,2]. The spatial stream signal x_{NSS} which is transmitted by antenna 112n and received at antenna 126n may be altered based on a channel estimate h[Nrx,Ntx].

At the MIMO receiver 106, each of the FFT blocks 124a, 124b, . . . , and 124n may convert a corresponding received signal, r₁, r₂, . . . , and r_{Nrx}, from a time domain representation to a frequency domain representation. The signals received by antennas 126a, 126b, . . . , and 126n may be represented by the following system of equations:

$${r}_{1} = h [ 1 , 1 ] \cdot {x}_{1} + h [ 1 , 2 ] \cdot {x}_{2} + … + h [ 1 , Ntx ] \cdot {x}_{Ntx} + {n}_{1} \\ {r}_{2} = h [ 2 , 1 ] \cdot {x}_{1} + h [ 2 , 2 ] \cdot {x}_{2} + … + h [ 2 , Ntx ] \cdot {x}_{Ntx} + {n}_{2} \\ ⋮ \\ {r}_{Nrx} = h [ Nrx , 1 ] \cdot {x}_{1} + h [ Nrx , 2 ] \cdot {x}_{2} + … + h [ Nrx , Ntx ] \cdot {x}_{Ntx} + {n}_{Nrx} \qquad [ 2 ]$$

The detector block 122 may enable the MIMO receiver 106 to generate a plurality of soft decision values Lₖ₍₁₎, Lₖ₍₂₎, . . . , and L_{k(NSS)}. Each of the soft decision values Lₖ₍ᵢ₎ corresponds to a soft decision value for the k^{th} bit in the i^{th} spatial stream symbol. The bit corresponding to the soft decision value Lₖ₍ᵢ₎ may be represented by the notation bₖ₍ᵢ₎. The set of soft decision values Lₖ₍ᵢ₎ may be output from the detector block 122 and received by a decoder, which may utilize the soft decision values to generate decoded bits.

The receiver 106 may comprise functionality not shown in FIG. 2, which is commonly present in receiver and/or transceiver systems. Such circuitry may comprise, for example, decoder circuitry, which generates bit values based on soft decision values and interleaver circuitry, which merges bits from a plurality of spatial streams and/or received RF chains, into a single bit stream.

The maximum quantity of information, which may be transmitted by a MIMO transmitter 102 and received, via communication channel, at a MIMO receiver 106 is referred to as a channel capacity. Channel capacity is typically measured in units of bits/second/Hz. Channel capacity may be related to a MIMO channel quality index (CQI) value and/or to a MIMO mutual information value.

CQI represents a quality measure for the communication channel. CQI is typically measured in units of decibels (dB). CQI values are related to signal to noise ratio (SNR) values in the respect that an SNR value may be computed at a MIMO receiver 106 from received signals R (as shown in equation [1]) whereas a CQI value represents a prediction of an SNR value. The CQI value may be computed based on the channel estimate matrix H. Since the computed channel estimate matrix H is a representation of a communication channel, H may also be referred to as a channel realization.

Referring to FIG. 2, a K×K channel realization matrix H may represent the communication channels h[1,1], h[1,2], . . . , h[1,Ntx], h[2,1], h[2,2], . . . , h[2,Ntx], h[Nrx,1], h[Nrx,2], . . . and h[Nrx,Ntx]. In an exemplary embodiment of the invention, the MIMO receiver 106 may compute the channel realization matrix H based on signals received from the MIMO transmitter 102. The computed channel realization matrix H may subsequently be communicated to the MIMO transmitter 102. In another exemplary embodiment of the invention, the MIMO transmitter 102 may compute a channel realization matrix H based on signals received from the MIMO receiver 106. In either case, the MIMO transmitter 102 may compute one or more CQI values based on a channel realization matrix H. In various embodiments of the invention, the MIMO transmitter 102 may select one or more coding rates, for subsequent encoding of data in spatial streams x₁ and/or x₂, based on the computed CQI value(s).

Various embodiments of the invention comprise a method and system for predicting CQI values for a K×K MIMO communication system. The CQI prediction may be utilized at a MIMO transmitter 102 to maximize the rate at which information is transmitted by the MIMO transmitter 102 and successfully received at the MIMO receiver 106.

In a MIMO communication system, channel capacity represents the maximum rate at which information is transmitted by a MIMO transmitter 102 and successfully received by a MIMO receiver 106. Information is successfully received when the information encoded in transmitted signals X at the MIMO transmitter 102 are detected from received signals R at the MIMO receiver 106. Information may be unsuccessfully received when bit errors are detected in the received signals. The successful rate of information reception at the MIMO receiver 106 may be referred to as information throughput. The channel capacity value corresponds to a maximum information throughput value.

Based on, for example, preamble information in received signals, the MIMO receiver 106 may compute a channel realization matrix H. Based on the computed channel realization matrix and on detected information in the received signals, the MIMO receiver 106 may compute a channel quality measure, CQI(H). The computed CQI(H) may correspond to a rate at which bit errors are detected in the received signals. This rate, which is referred to as a bit error rate (BER), represents the number of bit errors detected among a given number of bits detected from the received signals. A rate for transmitted packets is referred to a packet error rate (PER). Accordingly, the PER for a MIMO communication system may be represented as a function of the channel realization H: PER(H).

To enable a MIMO receiver 106 to detect when a bit error occurs, the information, which is transmitted by a MIMO transmitter 102, is typically transmitted with additional data, which may be utilized at a MIMO receiver 106 to detect and/or correct bit errors in the information detected from the received signals. The additional data typically comprises forward error correction (FEC) coding (or inner coding, for example) data. Examples of inner codes comprise block convolutional codes (BCC) and turbo codes. The ratio of the number of information bits, i_{b} to the total transmitted bits, t_{b} (which include information and FEC data), is referred to as a coding rate, r_{c}. The information and additional data may be collectively referred to as encoded information.

The rate at which encoded information is transmitted by a MIMO transmitter 102, as measured in bits/second, may be determined based on the aggregate rate at which symbols are transmitted, r_{sym}. Accordingly, by increasing the number of bits represented by each transmitted symbol, MOD(i) (where i represents a spatial stream index value for which iε(1, 2, . . . , NSS)), the encoded information transmission rate may be increased. However, increasing MOD(i) at the MIMO transmitter 102 may result in an increase the BER as observed at the MIMO receiver. This may reduce information throughput.

Increasing the number of FEC data bits transmitted by the MIMO transmitter may increase the ability of the MIMO receiver to detect and/or correct bit errors in detected information. However, while increasing the number of FEC data bits may not change the encoded information transmission rate, the increased number of FEC data bits may reduce the coding rate. The reduction in the coding rate may correspond to a reduction in the information transfer rate, which refers to the effective transmission rate for unencoded information. This, in turn, may reduce the information throughput rate at the MIMO receiver.

Thus, given a modulation type for each spatial stream, or value MOD(i) for the i^{th} spatial stream (where 1≦i≦NSS) in a K×K MIMO system, maximizing the information throughput rate at the MIMO receiver 106 may depend upon the selection of a corresponding coding rate, r_{c}(i), at the MIMO transmitter 102. In various embodiments of the invention, the selected coding rate r_{c}(i) may be determined based on a computed CQI value for the i^{th} spatial stream, qᵢ^{K}, where the CQI value q₁^{K} for a K×K MIMO system is computed as a sum of CQI values qᵢⱼ for a series of independent 2×2 MIMO systems. Each of the 2×2 MIMO systems comprises a spatial stream xᵢ and a spatial stream xⱼ, each of which comprises a spatial stream that is selected from the K×K MIMO system.

In various embodiments of the invention, a K×K MIMO system may be modeled as a series of independent 2×2 MIMO systems. Each spatial stream signal in the K×K MIMO system may be detected by utilizing a method and system for approximate ML detection, for example, as is described in U.S. patent application Ser. No. 12/207,721 filed Sep. 10, 2008, which is hereby incorporated herein by reference in its entirety.

In an exemplary embodiment of the invention, each of the independent 2×2 MIMO systems may be associated with a corresponding 2×2 channel realization matrix H. Turning our attention for the time being to a selected one of the independent 2×2 MIMO systems, the processor 312 within the MIMO transmitter 102 may map the 2×2 channel realization matrix H to a plurality of CQI values q₁ and q₂, where q₁ is a CQI value for the first spatial stream associated with the selected independent 2×2 MIMO system, x₁, and q₂ is a CQI value for the second spatial stream associated with the selected independent 2×2 MIMO system, x₂. The CQI value q₁ is a CQI value corresponding to the spatial stream x₁ at the MIMO transmitter 102 and soft decision values Lₖ₍₁₎ at the MIMO receiver 106. Similarly, the CQI value q₂ is a CQI value corresponding to the spatial stream x₂ at the MIMO transmitter 102 and soft decision values Lₖ₍₂₎ at the MIMO receiver 106.

In various embodiments of the invention, the CQI values q₁ and q₂ may be determined by generating a singular value decomposition of the channel realization matrix H, as shown in the following equation:

H=USV^{H} [3]

where the matrix of singular values, S, may be represented as shown in the following equation:

$$S = [ \begin{matrix}{s}_{1} & 0 \\ 0 & {s}_{2}\end{matrix} ] \qquad [ 4 a ]$$

and the unitary matrix, V, may be represented as shown in the following equation:

$$V = [ \begin{matrix}1 & 0 \\ 0 & {e}^{- j \cdot θ}\end{matrix} ] \cdot [ \begin{matrix}cos φ & - sin φ \\ sin φ & cos φ\end{matrix} ] \qquad [ 4 b ]$$

where θ and φ represent angles.

The CQI values q₁ and q₂ may be represented as functions of the singular values s₁ and s₂, and of the angles θ and φ: q₁(s₁,s₂,θ,φ) and q₂(s₁,s₂,θ,φ). The CQI values for a given CQI function qᵢ(s₁,s₂,θ,φ) may reflect symmetries based on the parameters θ and φ as shown in the following equations:

qᵢ(s₁,s₂,θ,φ)=qᵢ(s₁,s₂,θ+π/2,φ)

qᵢ(s₁,s₂,θ,φ)=qᵢ(s₁,s₂,π/2−θ,φ)

qᵢ(s₁,s₂,θ,φ)=qᵢ(s₁,s₂,θ,φ+π)

qᵢ(s₁,s₂,θ,φ)=qᵢ(s₁,s₂,θ,π−φ) [5]

In addition, the relationship between the CQI values q₁(s₁,s₂,θ,φ) and q₂(s₁,s₂,θ,φ) may be represented as shown in the following equation:

q₂(s₁,s₂,θ,φ)=q₁(s₁,s₂,π/2−θ,π/2−φ) [6]

Consequently, given a CQI value q₁(s₁,s₂,θ,φ), for example, the other CQI value, for example q₂(s₁,s₂,θ,φ), may be computed based on equation [6]. Accordingly, based on the symmetrical relationships shown in equations [5] and [6], values for the parameter θ may be limited to

$$θ ∈ [ 0 , \frac{π}{4} ]$$

while values for the parameter φ may be limited to

$$φ ∈ [ 0 , \frac{π}{2} ] .$$

In various embodiments of the invention, the CQI values for the selected 2×2 MIMO communication system may be predicted based on corresponding CQI values for a SISO communication system. Accordingly, the CQI values for the MIMO communication system, q₁ and q₂, may be computed by approximating the selected 2×2 MIMO system shown in FIG. 2 as two independent single input single output (SISO) communication systems. With reference to FIG. 2, an exemplary SISO communication system may comprise a SISO transmitter, which comprises a single transmitting antenna, for example transmitting antenna 112a, and a SISO receiver may comprise a single receiving antenna, for example receiving antenna 126a. The SISO transmitter may utilize the single transmitting antenna to transmit data from a single spatial stream, for example spatial stream x₁. The SISO receiver may utilize the single receiving antenna to receive a single signal r₁. The relationship between the transmitted spatial stream signal from the SISO transmitter x_{SISO} and received signal r_{SISO} at the SISO receiver may be represented as shown in the following equation:

r_{SISO}=h_{SISO}·x_{SISO}+n_{AWGN} [7]

where h_{SISO} represents the channel realization for a SISO communication channel and n_{AWGN} represents additive white Gaussian distributed noise. The received signal r₁ may be detected by a detector, for example the detector 122, to generate soft decision values Lₖ₍₁₎. The CQI value for the SISO communication system may be referred to as q_{SISO}.

In various embodiments of the invention, a mapping between the CQI value, CQI(H), for the selected 2×2 MIMO system, and the CQI value, q_{SISO}, for the SISO system may be represented as shown in the following equation:

$${PER}_{MIMO , {x}_{1}} ( H ) = {PER}_{SISO} ( {q}_{SISO} ) \qquad [ 8 ]$$

where

$${PER}_{MIMO , {x}_{1}} ( H )$$

represents the PER as a function of the MIMO channel realization H for spatial stream x₁ and

$${PER}_{SISO} ( {q}_{SISO} )$$

represents the PER as a function of the SISO CQI value q_{SISO}.

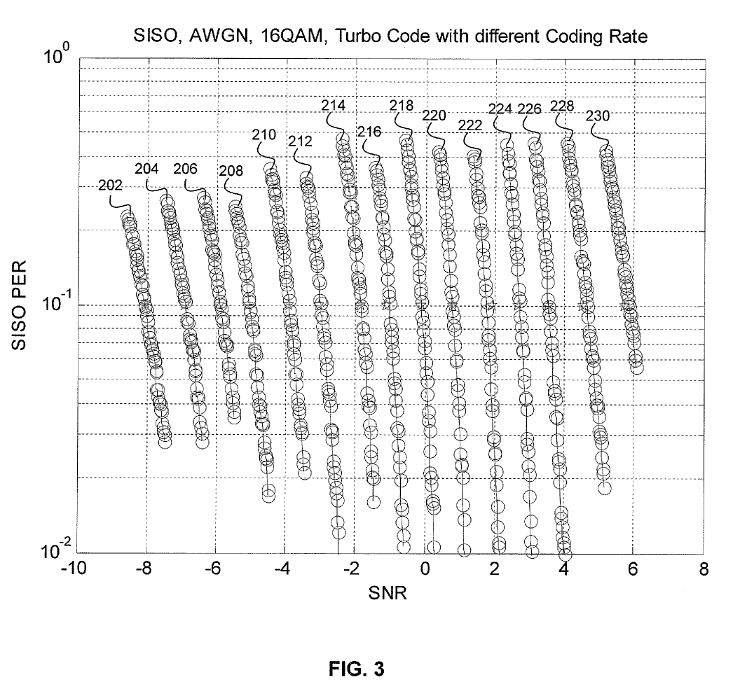

FIG. 3 is a graph that presents PER values as a function of SNR for an exemplary SISO communication system, in accordance with an embodiment of the invention. FIG. 3 presents a graphical representation of

$${PER}_{SISO} ( {q}_{SISO} )$$

versus SISO CQI values q_{SISO}. Referring to FIG. 3, there is shown a plurality of PER curves 202, 204, 206, 208, 210, 212, 214, 216, 218, 220, 222, 224, 226, 228 and 230. Each of the PER curves corresponds to a distinct coding rate, r_{c}. Each of the PER curves comprises a plurality of sample values, which were computed for an exemplary SISO communication system for which the modulation type is 16-level quaternary amplitude modulation (16-QAM), the inner code method is a turbo code, and noise is AWGN distributed. The SNR values shown in FIG. 3 correspond to values for q_{SISO}. While FIG. 3 presents PER curves for a 16-QAM modulation type, various embodiments of the invention are not so limited and may be practiced in connection with other modulation types, for example 64-QAM, 256-QAM or 1024-QAM. Similarly, various embodiments of the invention may be practiced in connection with FEC code types other than turbo coding, for example BCC.

Based on equation [8], the value q_{SISO} may be represented as shown in the following equation:

$${q}_{SISO} = {{PER}_{SISO}}^{- 1} ( {PER}_{MIMO , {x}_{1}} ( H ) ) \qquad [ 9 ]$$

where f⁻¹(g(x)) represents a reverse mapping of the function g(X) based on the function f. In other words, equation [9] presents a mapping between the SISO CQI q_{SISO} and the PER for the spatial stream x₁ in the selected 2×2 MIMO communication system.

In an exemplary embodiment of the invention, equation [9], and the plurality of SISO PER curves 202, 204, 206, 208, 210, 212, 214, 216, 218, 220, 222, 224, 226, 228 and 230 (FIG. 3), may be utilized to establish a correspondence between PER values

$${PER}_{MIMO , {x}_{1}} ( H )$$

for the selected 2×2 MIMO system and the CQI values q_{SISO} for a SISO system.

In various embodiments of the invention, a plurality of channel realization values Hₙ may be generated for 1≦n≦Nₛₐₘₚₗₑ where Nₛₐₘₚₗₑ represents the number of channel realizations generated in a sample set. For each generated channel realization, Hₙ, a coding rate value, r_{c,n}, may be selected for information transmitted by a MIMO transmitter 102. The MIMO transmitter 102 may transmit signals to a MIMO receiver 106. At the MIMO receiver 106, a corresponding PER value for spatial stream x₁,

$${PER}_{MIMO , {x}_{1}} ( {H}_{n} ) ,$$

may be computed based on the received signals. Based on the selected coding rate r_{c,n} for the MIMO system, a corresponding SISO curve 202, 204, 206, 208, 210, 212, 214, 216, 218, 220, 222, 224, 226, 228 or 230 may be selected in FIG. 3. Based on the computed value

$${PER}_{MIMO , {x}_{1}} ( {H}_{n} )$$

a corresponding SISO PER value may be selected in FIG. 3, for example. Based on the selected SISO PER value and the selected coding rate r_{c,n}, a corresponding SISO SNR value may be selected in FIG. 3, for example. A value q_{SISO,n} may correspond to the selected SISO SNR value.

In various embodiments of the invention, each computed PER value

$${PER}_{MIMO , {x}_{1}} ( {H}_{n} )$$

corresponds to a channel realization Hₙ. Accordingly, once the association between the computed value

$${PER}_{MIMO , {x}_{1}} ( {H}_{n} )$$

and the selected SISO SNR value q_{SISO,n} is established, there is a corresponding association between the channel realization Hₙ and the selected SISO SNR value q_{SISO,n}. Consequently, a plurality of (q_{SISO,n},Hₙ) tuples may be generated. Each tuple (q_{SISO,n},Hₙ) may be stored in a memory 314 (FIG. 1). The plurality of channel realization samples Hₙ may be represented as a vector, X.

In various embodiments of the invention, the reverse mapping function shown in equation [9] may be generated based on the plurality of tuple values (q_{SISO,n},Hₙ) by utilizing radial basis function (RBF) networks. In an exemplary embodiment of the invention, an reverse mapping function, f(X), may be computed as shown in the following equation:

$$f ( X ) = {λ}_{0} + {\sum }_{i = 1}^{{n}_{r}} {λ}_{1} \cdot φ ( ‖ X - {c}_{i} ‖ ) \qquad [ 10 ]$$

where values X correspond to sample values Hₙ, values f(X) correspond to values q_{SISO,n}, cᵢ represents RBF center values, nᵣ represents the number of RBF center values, λ₀ and λᵢ represent weighting coefficients and φ(ν) represents an RBF basis function. The notation ∥ν∥ represents a Euclidean norm computation. In an exemplary embodiment of the invention, the RBF basis function may utilize a Gaussian basis function, which may be represented as shown in the following equation:

φ(ν)=exp(−ν²/β²) [11]

where β may represent a constant value, for example β=3.5.

In an exemplary embodiment of the invention, the RBF center values, cᵢ, may be selected from the plurality of sample values Hₙ. Values for the weighting coefficients λ₀ and λᵢ may be computed by utilizing an orthogonal least square learning algorithm.

In various embodiments of the invention, the function f(X), which is computed using RBF networks as shown in equation [10], may be utilized for CQI prediction in a MIMO receiver 106 with ML detection. A processor 312, which is utilized in connection with a MIMO receiver 106, may compute a channel realization H based on signals received at the MIMO receiver 106. In an exemplary embodiment of the invention, the MIMO receiver 106 may communicate the computed channel realization H to the MIMO transmitter 102. A processor 312, which is utilized in connection with the MIMO transmitter 102, may use the reverse mapping function f(X), as computed in equation [10], and the received channel realization H to determine a CQI value, q₁, which corresponds to the spatial stream x₁. Once a CQI value q₁ is determined, a corresponding CQI value, q₂, which corresponds to the spatial stream x₂, may be determined as shown in equation [6]. Based on the determined CQI value(s) q₁ and/or q₂, the processor 312, which is utilized in connection with the MIMO transmitter 102, may select coding rates r_{c,1} and r_{c,2} for spatial streams x₁ and x₂, respectively. In an exemplary embodiment of the invention, a lookup table (LUT) may be utilized to select a coding rate r_{c,i} and/or modulation type (identified based on a MOD(i) value, for example) for an i^{th} spatial stream (where 1≦i≦NSS). The MIMO transmitter 102 may utilize the selected coding rates to generate subsequent encoded information, which may be transmitted from the MIMO transmitter 102 to the MIMO receiver 106 via the communication medium 104. In various embodiments of the invention, the selected coding rates may enable the MIMO transmitter 102 to maximize information throughput at the MIMO receiver 106 for a given channel realization H, which represents signal transmission characteristics of the communication medium 104.

In various embodiments of the invention the method and system for CQI prediction for a 2×2 MIMO system with ML detection may be practiced in connection with a K×K MIMO system by utilizing approximate ML detection.

In various embodiments of the invention a detector 122 for approximate ML detection in a K×K MIMO system may utilize a matched filter when processing a received signal vector R (equation [1]) to enable generation of the soft decision values Lₖ₍₁₎, Lₖ₍₂₎ and/or L_{k(NSS)}. In an exemplary embodiment of the invention, the detector 122 may utilize a matched filter, W₁, to enable generation of the soft decision values Lₖ₍₁₎. The product of the matched filter W₁ and the channel realization matrix H is as shown in the following equation:

$${W}_{1} H = [ \begin{matrix}{a}_{1} & 0 & 0 & 0 \\ {b}_{1} & {c}_{1} & 0 & 0 \\ {d}_{1} & 0 & {e}_{1} & 0 \\ {f}_{1} & 0 & 0 & {g}_{1}\end{matrix} ] \qquad [ 12 ]$$

where a₁, b₁, c₁, d₁, e₁, f₁ and g₁ are coefficients and:

$${W}_{i} \times {W}_{i}^{H} = [ \begin{matrix}1 & 0 & … & 0 \\ 0 & 1 & d c & d c \\ ⋮ & d c & 1 & d c \\ 0 & d c & d c & 1\end{matrix} ] \qquad [ 13 ]$$

where “dc” refers to one or more “don't care” matrix element values. A don't care value refers to a matrix element value, which may or may not be equal to zero (0).

The matrix product shown in equation [12], which may result from processing of the received signal vector R by the matched filter W₁, may enable detection of a first spatial stream x₁ from the received signal vector R, and subsequent generation of the soft decision values Lₖ₍₁₎, based on approximate ML detection methods. A log-likelihood ratio for computation of soft decision values Lₖ₍₁₎ is shown in the following equation:

$${L}_{k ( 1 )} = \frac{1}{{σ}^{2}} ( {min}_{{\hat{x}}_{1} \vert {b}_{k ( 1 )} = 0} - {min}_{{\hat{x}}_{1} \vert {b}_{k ( 1 )} = 1} ) ( \begin{matrix}\begin{matrix}\begin{matrix}{\vert {y}_{1 , 1} - {a}_{1} \cdot {\hat{x}}_{1} \vert}^{2} + \\ {\vert {y}_{1 , 2} - {b}_{1} \cdot {\hat{x}}_{1} - {c}_{1} \cdot {\hat{x}}_{2} \vert}^{2} +\end{matrix} \\ {\vert {y}_{1 , 3} - {d}_{1} \cdot {\hat{x}}_{1} - {e}_{1} \cdot {\hat{x}}_{3} \vert}^{2} +\end{matrix} \\ {\vert {y}_{1 , 4} - {f}_{1} \cdot {\hat{x}}_{1} - {g}_{1} \cdot {\hat{x}}_{4} \vert}^{2}\end{matrix} ) \qquad [ 14 ]$$

where \hat{x}ⱼ represents a candidate constellation point value, which may be selected from a constellation associated with a j^{th} spatial stream xⱼ. The log-likelihood ratio shown in equation [14] may be represented as shown in the following equation:

$${L}_{k ( 1 )} = \frac{1}{{σ}^{2}} ( {min}_{{\hat{x}}_{1} \vert {b}_{k ( 1 )} = 0} - {min}_{{\hat{x}}_{1} \vert {b}_{k ( 1 )} = 1} ) ( \begin{matrix}{\vert {y}_{1 , 1} - {a}_{1} \cdot {\hat{x}}_{1} \vert}^{2} + \\ {\vert {y}_{1 , 2} - {b}_{1} \cdot {\hat{x}}_{1} - {S}_{MOD ( 2 )}^{{c}_{1}} ( {y}_{1 , 2} - {b}_{1} \cdot {\hat{x}}_{1} ) \vert}^{2} + \\ {\vert {y}_{1 , 3} - {d}_{1} \cdot {\hat{x}}_{1} - {S}_{MOD ( 3 )}^{{e}_{1}} ( {y}_{1 , 3} - {d}_{1} \cdot {\hat{x}}_{1} ) \vert}^{2} + \\ {\vert {y}_{1 , 4} - {f}_{1} \cdot {\hat{x}}_{1} - {S}_{MOD ( 4 )}^{{g}_{1}} ( {y}_{1 , 4} - {f}_{1} \cdot {\hat{x}}_{1} ) \vert}^{2}\end{matrix} ) \qquad [ 15 ]$$

where S_{MOD(j)}^{m}(z(\hat{x}₁)) refers to a sliced value for z, where z is represented as a function of \hat{x}₁.

Based on equation [15], a CQI value, q₁^{K}, for the spatial stream signal x₁ in the K×K MIMO system may be computed as shown in the following equation:

q₁^{K}=q₁₀+(q₁₂−q₁₀)+(q₁₃−q₁₀)+(q₁₄−q₁₀) [16]

where q₁₀ represents a zero-forcing CQI value, which may be computed for a SISO system comprising spatial stream signal x₁, q₁₂ represents the CQI value, q₁, which may be computed for a 2×2 MIMO system comprising spatial stream signals x₁ and x₂, q₁₃ represents the CQI value, q₁, which may be computed for a 2×2 MIMO system comprising spatial stream signals x₁ and x₃ and q₁₄ represents the CQI value, q₁, which may be computed for a 2×2 MIMO system comprising spatial stream signals x₁ and x₄. Similarly, CQI values q₂^{K}, q₃^{K}, . . . and q_{K}^{K} may be computed for the spatial stream signals x₂, x₃, . . . and x_{K} (where K=NSS), respectively.

In an exemplary embodiment of the invention, a processor 312, which is utilized in connection with the MIMO receiver 106, may compute a channel realization H matrix based on received signals. The processor 312 may generate a matched filter matrix, Wᵢ, as shown in equations [12] and [13], for example. The matched filter matrix Wᵢ may be utilized to detect an i^{th} spatial stream at the MIMO receiver 106. For example, for detection of a spatial stream x₁ in a K×K MIMO system, i=1.

In the exemplary case where i=1, the matched filter matrix W₁ may enable the processor to compute a CQI value for the 1^{st} spatial stream, q₁^{K}, by decomposing the K×K MIMO system into a series of independent 2×2 MIMO systems. The processor 312 may compute a zero-forcing CQI value q₁₀ for the detected spatial stream x₁. The zero-forcing CQI q₁₀ may be computed based on the reverse mapping function f(X=a₁) (equation [10]) for the coefficient value a₁ (equation [12]). The processor 312 may also compute a set of CQI values q₁₂, q₁₃, . . . and q_{1NSS}, corresponding to a series of 2×2 MIMO systems, for the spatial stream x₁. Each of the computed CQI values q₁ⱼ (for j≠0) may correspond to a selected 2×2 MIMO system, which comprises spatial stream signals x₁ and xⱼ, where xⱼ is selected from the plurality of spatial stream signals x₁, x₂, . . . , x_{NSS}.

Once a zero-forcing CQI value q₁₀, and a set of CQI values q₁₂, q₁₃, . . . and q_{1NSS}, has been determined, a corresponding CQI value, q₁^{K} which corresponds to a CQI value for the spatial stream x₁, may be determined for a K×K MIMO system as shown in equation [16]. Based on the computed CQI value, q₁^{K}, a coding rate r_{c}(1) may be selected. Coding rates r_{c}(2), r_{c}(3), . . . and r_{c}(NSS) may be similarly selected. The plurality of selected coding rates r_{c}(1), r_{c}(2), . . . and r_{c}(NSS) may be communicated by the MIMO receiver 106 to the MIMO transmitter 102. The MIMO transmitter 102 may transmit subsequent signals to the MIMO receiver 106 by utilizing at least a portion of the selected coding rates r_{c}(1), r_{c}(2), . . . and r_{c}(NSS).

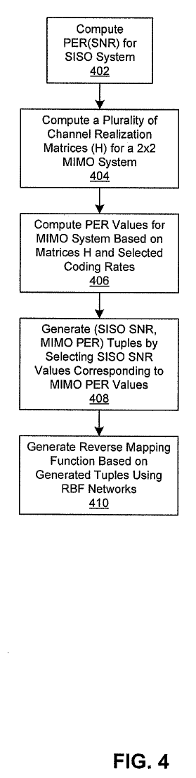

FIG. 4 is a flowchart illustrating exemplary steps for generating a reverse mapping function utilizing radial basis function networks, in accordance with an embodiment of the invention. Referring to FIG. 4, in step 402, a processor 312 may be utilized to compute a plurality of packet error rate (PER) values as a function of SNR for a SISO communication system. The PER values may be computed based on a plurality of selected coding rate values. The plurality of PER values and SNR values may be stored in a memory 314.

In step 404, the processor 312 may be utilized to compute a plurality of channel realization matrices (H) for a 2×2 MIMO communication system. In step 406, the processor 312 may be utilized select one or more coding rates and to compute a plurality of PER values for a 2×2 MIMO communication system based on the selected coding rate(s) and on the computed channel realization matrices. In an exemplary embodiment of the invention, the computed MIMO PER values may be associated with a selected spatial stream in the 2×2 MIMO communication system, for example the first spatial stream, x₁. The plurality of PER values for the 2×2 MIMO communication system may be stored in the memory 314.

In step 408, the processor 312 may be utilized to associate individual MIMO PER values with corresponding SISO SNR values by selecting a SISO SNR value that corresponds to a MIMO PER value based on a selected coding rate. The processor may generate a plurality of tuples, each comprising a MIMO channel realization matrix (H) and corresponding SISO SNR value based on the selected coding rate. In step 410, the processor 312 may utilize the generated tuples to generate a reverse mapping function using RBF networks.

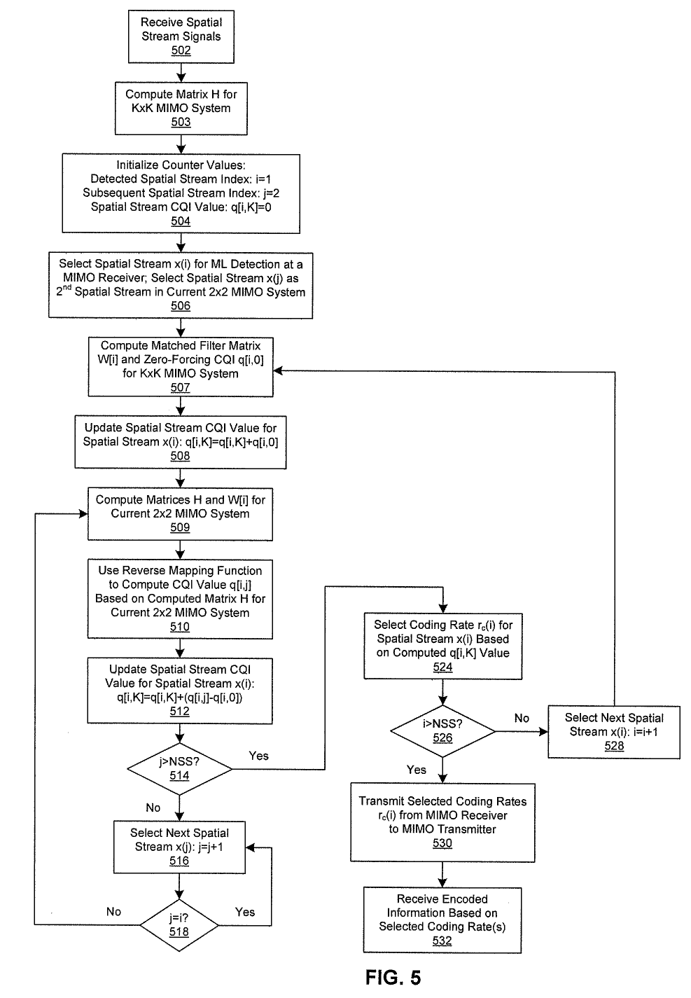

FIG. 5 is a flowchart illustrating exemplary steps for CQI prediction utilizing radial basis function networks, in accordance with an embodiment of the invention. Referring to FIG. 5, in step 502, a MIMO receiver 106 may receive spatial stream signals from a MIMO transmitter 102. In step 503, a processor 312, which is utilized in connection with the MIMO receiver 106, may compute a channel realization matrix H for a K×K MIMO system. In step 504, the processor 312 may initialize a plurality of counter values, which comprise a detected spatial stream index, i, a subsequent spatial stream index j, and a spatial stream CQI value q[i,K]. The detected spatial stream index i refers to a spatial stream in the K×K MIMO system for which soft decision values Lₖ₍ᵢ₎ are computed. In step 504, i is initialized to a value equal to 1. The subsequent spatial stream index j refers to a spatial stream in the K×K MIMO system, which corresponds to a second spatial stream in a selected 2×2 MIMO system. In step 504, j is initialized to a value equal to 2. The CQI value q[i,K] corresponds to q₁^{K}, which is presented in equation [16]. In step 504, q₁^{K} is initialized to a value equal to 0 for all values i. The values i and j represent spatial streams in a selected current 2×2 MIMO system.

In step 506, the processor 312 may select spatial streams x(i) and x(j) for ML detection at a MIMO receiver in a current 2×2 MIMO system. In step 507, the processor 312 may compute a matched filter matrix W[i] and/or zero-forcing CQI value q[i,0], for the K×K MIMO system. In step 508, the processor 312 may update the spatial stream CQI value q[i,K] based on the computed zero-forcing CQI value. In step 509, the processor 312 may compute a channel realization matrix H, and/or matched filter matrix W[i], for the current 2×2 MIMO system. In step 510, the processor 312 may utilize a reverse mapping function to compute CQI value(s) q[i,j] for the selected 2×2 MIMO system based on the computed matrix H for the selected 2×2 MIMO system. The CQI value(s) q[i,j] may correspond to CQI values qᵢⱼ (for j≠0) as shown in equation [16]. In step 512, the processor 312 may update the current value q[i,K] by increasing the current value q[i,K] by an amount equal to (q[i,j]−q[i,0]), where q[i,j] is computed in step 510 and q[i,0] is computed in step 507.

Step 514 may determine whether the current subsequent spatial stream index value has pointed to the last spatial stream in the K×K MIMO system by determining whether j>NSS. In instances where j≦NSS at step 514, in step 516, the subsequent spatial stream index j is incremented to point to the next spatial stream in the K×K MIMO system. The next spatial stream then becomes the second spatial stream in a next selected 2×2 MIMO system. Step 516 may determine whether the subsequent spatial stream index value j is currently pointing to the detected spatial stream by determining whether the current values i and j are equal. In instances where i=j, step 516 may follow step 518. In instances where i≠j at step 518, step 508 may follow step 518.

In instances, at step 514, where j>NSS, in step 524, the processor 312 may select a coding rate r_{c}(i) for the spatial stream x(i) based on the current computed q[i,K] value. In various embodiments of the invention, the selected coding rate, r_{c}(i), may be determined from a lookup table (LUT), where the computed CQI value qᵢ^{K} may be utilized as an index value for selecting a coding rate r_{c}(i) from the LUT.

Step 526 may determine whether the current detected spatial stream index value has pointed to the last spatial stream in the K×K MIMO system by determining whether i>NSS. In instances where i≦NSS at step 526, in step 528, the detected spatial stream index i is incremented to point to the next spatial stream in the K×K MIMO system. The next spatial stream then becomes the first spatial stream in a next selected 2×2 MIMO system. Step 507 may follow step 528.

In instances, at step 526, where i>NSS, in step 530, the selected coding rates r_{c}(i) may be transmitted from the MIMO receiver 106 to the MIMO transmitter 102. Upon receipt of the selected coding rates, the MIMO transmitter 102 may utilize the selected coding rates to transmit subsequent spatial stream signals to the MIMO receiver 102. In step 532, the MIMO receiver 106 may receive subsequent encoded information based on the selected coding rates by detecting the subsequent received spatial stream signals via an ML detector 122, which is utilized in connection with the MIMO receiver 106.

Another embodiment of the invention may provide a computer readable medium having stored thereon, a computer program having at least one code section executable by a computer, thereby causing the computer to perform steps as described herein for predicting channel quality index (CQI) values for maximum likelihood (ML) detection in a K×K multiple input multiple output (MIMO) wireless system.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communicating information in a wireless communication system, the method comprising:
performing by one or more processors and/or circuits in a multiple input multiple output receiver system that utilizes maximum likelihood detection:
computing a channel realization matrix based on a plurality of spatial stream signals that are concurrently received via a plurality of receiving antennas;
identifying a plurality of two-stream receiver systems based on a selected detection spatial stream signal and corresponding remaining ones of said plurality of spatial stream signals;
computing a plurality of channel quality index values corresponding to said plurality of two-stream receiver systems;
computing a detection spatial stream channel quality index value for said selected detection spatial stream signal based on said computed plurality of channel quality index values;
selecting a coding rate for said detection spatial stream signal based on said computed detection spatial stream channel quality index value; and
concurrently receiving a subsequent plurality of spatial stream signals, wherein at least a portion of said received subsequent plurality of spatial stream signals comprise information that is encoded based on said selected coding rate.

2. The method according to claim 1, comprising computing a matched filter matrix based on said computed channel realization matrix.

3. The method according to claim 2, comprising computing a product matrix based on multiplication of said computed matched filter matrix and said computed channel realization matrix.

4. The matrix according to claim 3, comprising computing a zero-forcing channel quality index value for said selection detection spatial stream based on said computed product matrix and a reverse mapping function.

5. The method according to claim 4, comprising computing said detection spatial stream channel quality index value based on said computed zero-forcing channel quality index value.

6. The method according to claim 4, comprising computing a two-stream channel realization matrix for each corresponding one of said plurality of two-stream receiver systems based on said computed channel realization matrix.

7. The method according to claim 6, comprising computing a two-stream matched filter matrix for each corresponding one of said plurality of two-stream receiver systems based on a corresponding said computed two-stream channel realization matrix.

8. The method according to claim 7, comprising computing a two-stream product matrix for each corresponding one of said plurality of two-stream receiver systems based on multiplication of a corresponding said computed two-stream matched filter matrix and said corresponding computed two-stream channel realization matrix.

9. The method according to claim 8, comprising computing a two-stream channel quality index value corresponding to said selected detection spatial stream signal for each corresponding one of said plurality of two-stream receiver systems based on a corresponding said computed two-stream product matrix and said reverse mapping function.

10. The method according to claim 9, comprising computing each of said plurality of channel quality index values based on said computed zero-forcing channel quality index value and a corresponding said computed two-stream channel quality index value.

11. The method according to claim 1, comprising transmitting said computed channel quality index value and/or said selected coding rate via one or more transmitting antennas.

12. A system for communicating information in a wireless communication system, the system comprising:
one or more circuits that are operable for computing a channel realization matrix based on a plurality of spatial stream signals that are concurrently received via a plurality of receiving antennas;
said one or more circuits are operable for identifying a plurality of two-stream receiver systems based on a selected detection spatial stream signal and corresponding remaining ones of said plurality of spatial stream signals;
said one or more circuits are operable for computing a plurality of channel quality index values corresponding to said plurality of two-stream receiver systems;
said one or more circuits are operable for computing a detection spatial stream channel quality index value for said selected detection spatial stream signal based on said computed plurality of channel quality index values;
said one or more circuits are operable for selecting a coding rate for said detection spatial stream signal based on said computed detection spatial stream channel quality index value; and
said one or more circuits are operable for concurrently receiving a subsequent plurality of spatial stream signals, wherein at least a portion of said received subsequent plurality of spatial stream signals comprise information that is encoded based on said selected coding rate.

13. The system according to claim 12, wherein said one or more circuits are operable for computing a matched filter matrix based on said computed channel realization matrix.

14. The system according to claim 13, wherein said one or more circuits are operable for computing a product matrix based on multiplication of said computed matched filter matrix and said computed channel realization matrix.

15. The system according to claim 14, wherein said one or more circuits are operable for computing a zero-forcing channel quality index value for said selection detection spatial stream based on said computed product matrix and a reverse mapping function.

16. The system according to claim 15, wherein said one or more circuits are operable computing said detection spatial stream channel quality index value based on said computed zero-forcing channel quality index value.

17. The system according to claim 15, wherein said one or more circuits are operable for computing a two-stream channel realization matrix for each corresponding one of said plurality of two-stream receiver systems based on said computed channel realization matrix.

18. The system according to claim 17, wherein said one or more circuits are operable for computing a two-stream matched filter matrix for each corresponding one of said plurality of two-stream receiver systems based on a corresponding said computed two-stream channel realization matrix.

19. The system according to claim 18, wherein said one or more circuits are operable for computing a two-stream product matrix for each corresponding one of said plurality of two-stream receiver systems based on multiplication of a corresponding said computed two-stream matched filter matrix and said corresponding computed two-stream channel realization matrix.

20. The system according to claim 19, wherein said one or more circuits are operable for computing a two-stream channel quality index value corresponding to said selected detection spatial stream signal for each corresponding one of said plurality of two-stream receiver systems based on a corresponding said computed two-stream product matrix and said reverse mapping function.

21. The system according to claim 19, wherein said one or more circuits are operable for computing each of said plurality of channel quality index values based on said computed zero-forcing channel quality index value and a corresponding said computed two-stream channel quality index value

22. The system according to claim 12, wherein said one or more circuits are operable for transmitting said computed channel quality index value and/or said selected coding rate via one or more transmitting antennas.
